(19) United States
(12) Patent Application Publication
(10) Pub. No.: US 2012/0089405 A1
(43) Pub. Date: Apr. 12, 2012

(54) System and method for rewarding compliance with full or partial exclusive use of a web service provider

(75) Inventor: Talmon Marco, Tampa, FL (US)

(73) Assignee: MusicLab Ltd., Or Yehuda, IL (US)

(21) Appl. No.: 12/923,850

(22) Filed: Oct. 12, 2010

(51) Int. Cl. G06Q 30/00; G06F 15/173

(52) U.S. Cl. 705/1.1; 709/224

(57) ABSTRACT

A computerized system and method for rewarding compliant use of a designated web service (DS) provided by a designated web service provider (WSP), comprising: storing identification parameters for the designated WSP and for Other WSPs, storing a compliance definition comprising exclusivity and usage requirements, receiving a user's DS request, analyzing the DS request in view of the stored compliance definition, updating the user's compliance level according to the analysis result and rewarding the user if the updated compliance level indicates eligibility to a reward.

### FIELD OF THE INVENTION

The present invention relates generally to rewards programs and more specifically to rewarding web-service users based on the degree of exclusivity in using a specific web-service.

### BACKGROUND OF THE INVENTION

Companies providing web services may generate substantial income when users choose to use their service over competitors'. For example, companies such as Google, Yahoo and Microsoft are generating substantial income when users are using their web search service. Income is typically generated when users click on paid listings (“ads”) displayed alongside search results. For example, a user searching for “car insurance” may see several paid listings pointing at various car insurance providers. When the user clicks on such a paid listing, a fee will be paid by the car insurance company to the ad publisher (for example, Google).

Therefore and as evident by publicly available information such as Google's financial reports, customer use and loyalty to a specific Web Service Provider's (hereinafter a “WSP”) service carries with it a clear financial benefit to that WSP. Such is the benefit that a WSP may choose to reward users for their loyalty in various ways, such as goods, services, or even hard cash (the “Reward”).

US Published patent application no. 20080281706 to Sullivan provides a system and method for an affinity rewards program, also called a loyalty rewards program, that is administered by an Internet Service Provider (ISP). The affinity program allows for these service providers to provide their subscribers access to one or more affinity networks in a seamless fashion as a service of the ISP. The method comprises obtaining or generating one or more piece of identifying information for a user; providing the user access to one or more affinity programs; and providing the user results for a search for one or more products or services from affinity program advertisers.

US Published patent application no. 20080168099 to Skaf provides systems and methods of tracking and rewarding users of search engines, content networks, communication networks, other networks and/or combinations of networks. The tracked information can be used to provide rewards, customize offers and rewards and to improve services provided to the user.

US Published patent application no. 20020198782 to Shorter provides a system focused on long-term customer retention by applying an incentive on a monthly, on-going basis as a reward for loyalty. The method includes the steps of enrolling a user as a member of a customer network maintained by a subscription system operator, establishing a subscriber account with the service provider on behalf of a member of the customer network, the account having a predetermined basic monthly service cost, implementing a data base of service provider subscribers that indicates an association between each member and the member's referral subscribers, calculating a service credit for the member based upon activity of the referral subscribers, and applying the service credit to offset the member's predetermined basic monthly service cost.

US Published patent application no. 20020174011 to Sanchez et al provides a membership reward system for registering consumers as members of a membership reward program, and for providing offers to the members based upon the members' transactions with company partners of the membership program.

US Published patent application no. 20030163368 to Bastone provides a system and method for promoting a Web site using other services offered by the ISP hosting the site. The ISP provides a Web site hosting customer with the ability to offer an incentive to existing or potential customers of other ISP-provided services, so that those customers are motivated to visit and/or participate on the hosted Web site.

US Published patent application no. 20090265233 to Sendo et al provides a system and method permitting a primary online service to award and redeem incentive points to users of a social networking or other third-party site that operates independently of the primary online service. The primary online service publishes copies of a widget on the social networking site. The widget communicates with the social networking site through an API published by the operators of the social networking site. When user of the social networking site activates the widget, the primary website awards incentive points to the user based on the user's activities at the social networking site.

US Published patent application no. 20080319847 to Shepard provides a platform for a loyalty program providing an interface allowing a consumer to create a benefit tailored for his/her needs. In one embodiment, a consumer accesses the platform via a web-based interface, and selects benefit/reward parameters including but not limited to the nature of the event triggering award of the benefit, the source (i.e. retailer) of the benefit, the nature of the benefit (i.e., discount based upon purchase price or accumulated loyalty points), and/or the events allowing accrual of loyalty points.

US Published patent application no. 20030236701 to Rowney et als provides a system and method for managing promotion and reward arrangements between affiliated entities, the system comprising a promotion link generator for creating a link in a site owner computer system coupled to a network, the link corresponding to a promotion in an affiliate. A reward estimator calculates and tracks any site owner points awarded to the user for completing the qualifying activity required by the promotion in the affiliate system.

US Published patent application no. 20050240477 to Friday et als provides a system and method for implementing a program such as a loyalty program. An account system includes a plurality of participating account holders, a plurality of non-participating account holders, a plurality of non-preferred merchants and a plurality of preferred merchants. A processor executes the program including evaluating transactions to identify qualifying transactions involving both a participating account holders and a preferred merchant. Rebates are provided for identified, qualifying transactions.

The systems and methods provided all relate to rewarding users for using a specific service (e.g. web search) provided by the WSP. There is no consideration of the proportion of use of the specific service to the total uses of similar services, or to the number of uses of similar services provided by Other WSPs.

### SUMMARY OF THE INVENTION

The system and methods according to the present invention attempt to overcome the shortcomings of existing reward mechanism for web-compliance by taking into account not only the usage frequency of the designated service but also usage parameters relating to the usage of similar services provided by Other WSPs.

In a first aspect of the present invention there is provided a computerized method of rewarding compliant use of a designated web service (DS) provided by a designated web service provider (WSP), comprising: storing identification parameters for the designated WSP and for Other WSPs; storing a compliance definition comprising exclusivity and usage requirements; receiving a user's DS request; analyzing the DS request in view of the stored compliance definition; updating the user's compliance level according to the analysis result; and rewarding the user if the updated compliance level indicates eligibility to a reward.

In a second aspect of the present invention there is provided a system for rewarding compliant use of a designated web service (DS) provided by a designated web service provider (WSP), comprising: a user device capable of hosting a web server; a central web server communicating with the user device over the internet; a compliance mechanism communicating with the user device and with said central web server; and a reward mechanism communicating with the central server, wherein the compliance mechanism stores identification parameters for the designated WSP and for Other WSPs and a compliance definition comprising exclusivity and usage requirements.

### BRIEF DESCRIPTION OF THE DRAWINGS

For a better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic block diagram of a system for implementing the invention;

FIG. 2 is a flowchart generally outlining the method according to the present invention; and

FIGS. 3A and 3B are flowcharts describing the functionality of the compliance mechanism according to the present invention.

### DETAILED DESCRIPTION OF PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The present invention provides a system and methods for determining compliance with full or partial exclusive use of a Web Service Provider (WSP), or a group of WSPs, in exchange for services or goods. In the following description the partial or exclusive use of a specific WSP is discussed. However, a specific WSP in this context shall always apply to both a single WSP and a group of WSPs.

Fully Exclusive Use with No Usage Requirement

In the context of the invention, fully exclusive use with no usage requirement of a designated service (DS) from a WSP means that a user need not actually use a certain WSP. Rather, it means that the user may not use any Other WSP for providing the same DS. Should the user choose to use the services of a WSP for the DS, the user will have to use the services of the designated WSP. The definition of an Other WSP may vary and may be based on the use of an Other WSP from a fixed or dynamic list of Other WSPs, or may involve any other method of determining what an Other WSP is.

A user will be deemed to be compliant with full exclusive use with no usage requirement as long as no usage of an Other WSP for the DS occurs. A fixed or variable time requirement may be imposed, deeming the user to be in compliance only after a certain period in which no Other WSP has been used for the DS.

Fully Exclusive Use with Usaqe Requirement In the context of the invention, fully exclusive use with usage requirement of a designated WSP means that a user not only may not use an Other WSP for the DS, but should also make certain use of the designated WSP. The usage requirement may vary and may be based on absolute use volume per certain period or may vary and be tied to various parameters.

A user will be deemed to be compliant with full exclusive use with usage requirement as long as no usage of an Other WSP occurs for the DS and certain usage requirements are met. A fixed or variable time requirement may be imposed, deeming the user to be in compliance only after a certain period that no Other WSP has been used for the DS and certain usage requirements have been met.

Partially Exclusive Use with No Usage Requirement

In the context of the invention, partially exclusive use with no usage requirement of a WSP means that a user need not actually use a certain WSP. Rather, it means that the user may be limited in their usage of Other WSPs for the DS. Should the user choose to use the DS, the user will have limits on their usage of Other WSPs.

Such limitations of usage of Other WSPs may take various forms, but the overall concept is such that while usage of Other WSPs is permitted, usage of Other WSPs reduces the user's compliance level with the exclusivity requirement. The reduction in compliance may result in some form of reduction of the Reward given to the user, or the service may be unaffected until such point in time that the user is no longer considered to be in compliance with the exclusivity requirements at which point in time the Reward will stop. A mechanism for increasing compliance or becoming compliant again may be implemented. Such mechanism will involve a requirement for lesser or no usage of Other WSPs for the DS. This mechanism will operate so that usage of Other WSPs decreases compliance and lack of usage increases compliance. Compliance level may determine the Reward level or may operate via a fixed or dynamic threshold whereby once a user's compliance goes below a certain level the Reward will cease.

Partially Exclusive Use with Usage Requirement

In the context of the invention, partially exclusive use with usage requirement of a designated WSP means that a user should make certain use of the designated WSP for the DS, while being limited in their usage of Other WSPs. Should the user choose to use the DS, the user will have limits on their usage of Other WSPs. Further, the user should make certain use of the designated WSP. The usage requirement may vary and may be based on absolute use volume per certain period or may vary and be tied to various parameters.

Such limitations of usage of Other WSPs may take various forms, but the overall concept is such that while usage of Other WSPs for the DS is permitted, usage of Other WSPs reduces the user's compliance level with the exclusivity requirement. At the same time, usage requirements of the designated WSP will also affect the user's compliance.

Usage requirements may be implemented as minimum requirements to get a Reward, or they may determine the Reward level, or they may work hand in hand with the limitations on usage of Other WSPs in determining eligibility for Rewards.

Reduction in compliance as a result of usage of Other WSPs for the DS may result in some form of reduction of the Reward given to the user, or the service may be unaffected until such point in time that the user is no longer considered to be in compliance with the exclusivity requirements at which point in time the Reward will stop. A mechanism for increasing compliance or becoming compliant again may be implemented. Such mechanism may involve a requirement for lesser or no usage of Other WSPs and may also work together with usage requirement increasing compliance. This mechanism will operate so that usage of Other WSPs for the DS decreases compliance and lack of usage increases compliance. Compliance level may determine the Reward level or may operate via a fixed or dynamic threshold whereby once a user's compliance goes below a certain level the Reward will cease.

### Implementation

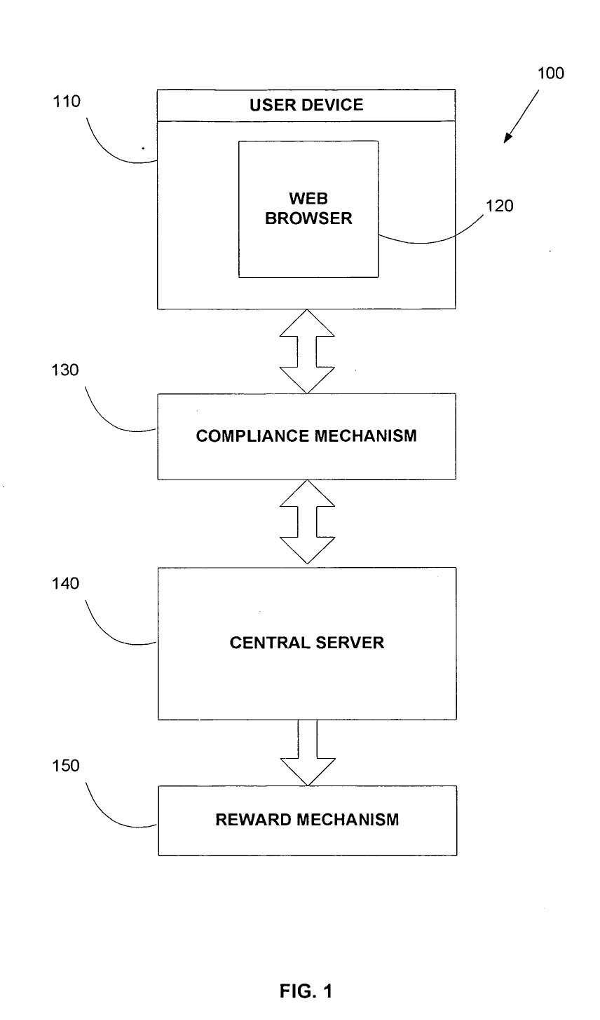

FIG. 1 is a schematic block diagram of a system, generally denoted 100, for implementing the invention.

The system comprises a user device 110, such as PC, PDA, mobile phone, or any other device capable of hosting a web-browser 120.

A software based compliance mechanism 130 communicates with the web browser in order to determine user compliance with the various forms of WSP exclusivity, as described above. The compliance mechanisms 130 may be installed on the user device 110 and/or anywhere at the network level, such as the user's Router, Switch, Network Gateway, Firewall or Internet Service Provider.

The compliance mechanism 130 is comprised of multiple components which may be implemented in a centralized component or as several distributed components. In this document we shall treat them all as implemented together. However, nothing should prevent the compliance mechanisms 130 from being implemented via several distributed components and such implementation is claimed as well.

The compliance mechanism should be aware of the designated WSP (or a group of designated WSPs) as well as the Other WSPs. The compliance mechanism should also be aware of the designated service (DS).

Obtaining the designated WSP or WSPs may be achieved in several ways:
1. Periodically update the Designated WSP list from a central server (such list may contain URLs, regular expressions and/or IP addresses of WSPs).
2. Pre-populate the Designated WSP list as part of the Compliance Mechanism so (such list may contain URLs, regular expressions and/or IP addresses of WSPs).
3. Check user's web requests in real time against a central server. Such server may contain the designated WSP or may determine it based on various methods such as e.g. business logic or pattern analysis. The server will then decide whether the request matches the designated WSP.
4. Any combination of 1, 2 and 3.

### Obtaining the Other WSPs May be Achieved in Several Ways:

1. Periodically update the Other WSP or WSPs list from a central server (such list may contain URLs, regular expressions and/or IP addresses of WSPs).
2. Pre-populate the Other WSP or list of Other WSPs as part of the Compliance Mechanism (such list may contain URLs, regular expressions and/or IP addresses of WSPs).
3. Check user's web requests in real time against a central server. Such server may contain the list of Other WSP or WSPs or may determine it based on a pattern analysis or some other method such as business logic. The server will then decide whether the request matches the Other WSP or WSPs. Any combination of 1, 2 and 3.

The compliance mechanism 130 communicates with a central server 140, which in turn communicates with a reward mechanism 150 for rewarding a compliant user with the designated reward. The reward mechanism 150 may be implemented as a software component on the central server, on the user's computing device, on the user's network path or as distributed components residing on both the central server and the user's computing device.

In case the Compliance Mechanism is implemented on the user's computing device, it can be implemented in different forms in order to capture and analyze HTTP traffic. Such forms can be:
1. Browser add-on/helper (such as BHO in case of Microsoft Internet Explorer or browser add-on in case of Mozilla Firefox or other browsers).
2. HTTP sniffer—system component capturing and analyzing all or partial network traffic.
3. Standalone Internet Browser that captures and analyzes all traffic.

In case the compliance mechanism is implemented on the user's network path, it will need to capture and analyze some or all of the network data. The Compliance Mechanism can be implemented as a software mechanism added to another device, such as a router or a gateway. It may also be implemented as a separate device or server that captures and analyzes some or all network data. Capturing the data can be done either by sitting inline in the network path, or by having another device send some or all of the data or a copy of some or all of the data to the Compliance Mechanism.

The compliance mechanism should be able to analyze the user's web usage, compare against the designated DS on the designated WSPs/Other WSPs and determine compliance level in accordance with the specific rules of the implementation, as described above.

The compliance mechanism will determine a user's eligibility for reward by using business logic, either hardcoded in the compliance mechanism and/or with the assistance of a central server. Rewarding eligibility will be communicated to the actual mechanism responsible for providing the Reward.

The compliance mechanism should be able to prevent tampering. Further, the compliance mechanism should ensure the authenticity of it server data in order to ensure the integrity of the WSP lists and other related data, which may be done by using cryptographic methods, such as encryption, authentication, digital signatures, etc.

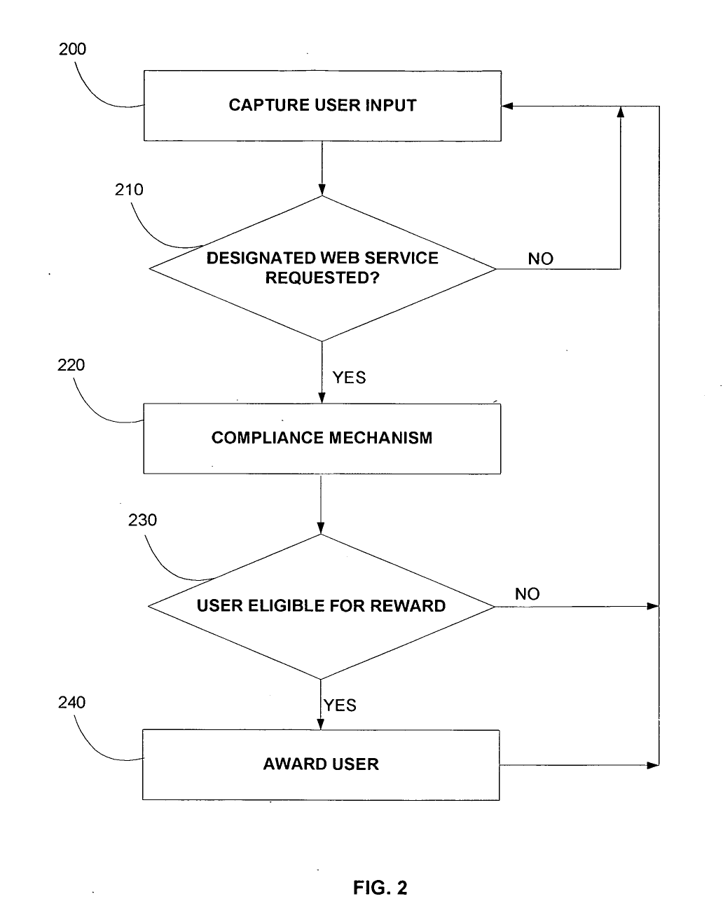

FIG. 2 is a flowchart generally outlining the method according to the present invention.

In step 200 the user's requested URL is captured and tested in step 210 to determine whether the designated web-service (DS) (e.g. web search) has been requested. If it is determined that the designated service has not been requested, the method goes back to step 200 to capture a next input.

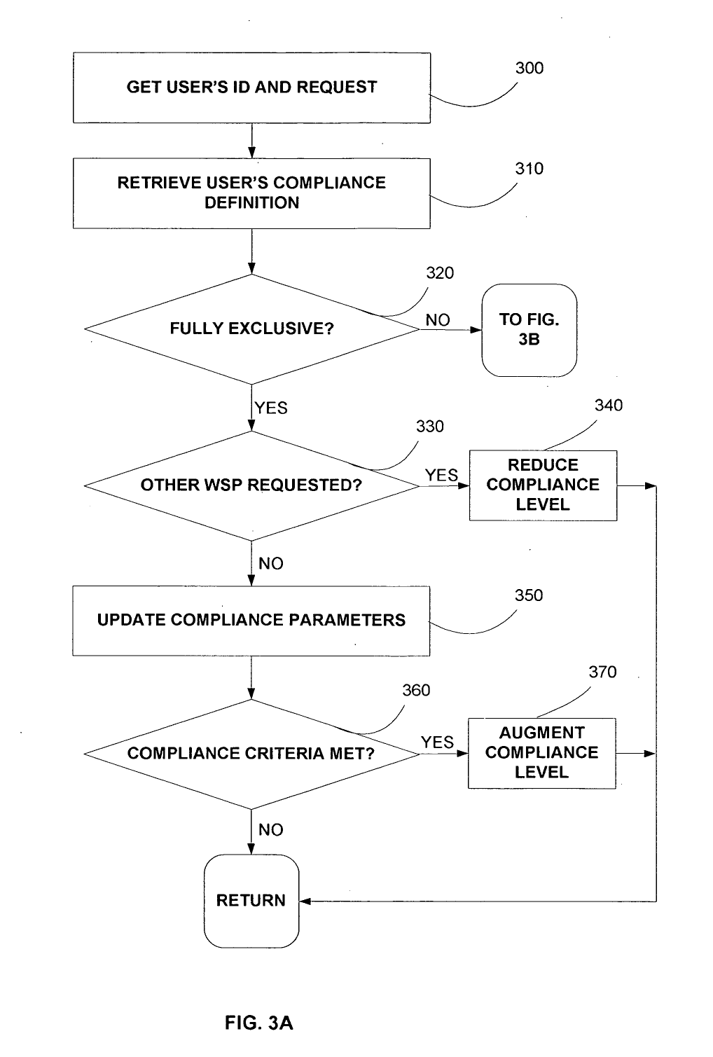

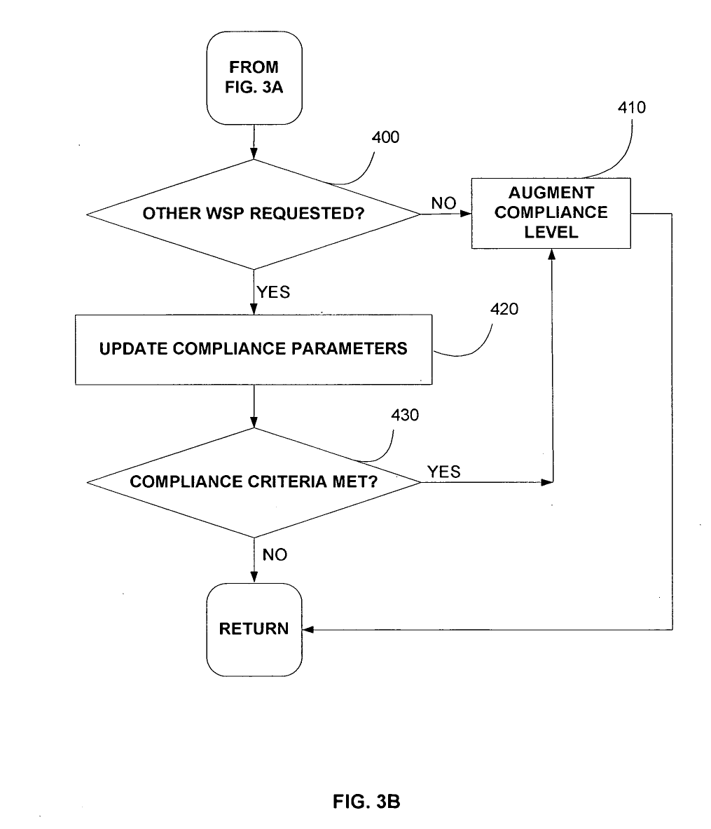

If in step 210 it was determined that the user has requested the DS, the user request is communicated to the compliance mechanism 130 (step 220), which will be described in detail with reference to FIGS. 3A and 3B.

In step 230, the user's compliance level, which may have been updated by the compliance mechanism 130, is tested and a decision is made whether the user is eligible for a reward, in which case the user is awarded the reward (step 240).

FIGS. 3A and 3B are flowcharts describing the functionality of the compliance mechanism 130.

In step 300 the compliance mechanism 130 receives the user's ID and the requested URL and in step 310 it retrieves the user's compliance definition from the central server 140, according to the user's ID. Alternatively, the system may comprise a unique compliance definition for all the users.

In step 320 the user's compliance definition is tested against the four variants described above, namely:
a. Fully exclusive use with no usage requirement.
b. Fully exclusive use with usage requirement.
c. Partially exclusive use with no usage requirement.
d. Partially exclusive use with usage requirement.

The compliance definition is first tested against variants (a) and (b), to determine whether full exclusivity is required for compliance. If the compliance definition requires full exclusivity, the user's request is tested to determine whether an Other WSP has been requested (step 330), in which case the user's compliance level is reduced in step 340.

If the requested WSP is the designated one, the new request is processed in view of other compliance parameters (step 350), to determine whether one or more compliance criteria have been met (step 360), as will be described in detail below. If it is determined that compliance criteria have been met, the user's compliance level is augmented in step 370.

If, in step 320 it was determined that the compliance definition is either (c) or (d), namely partial exclusivity is required for compliance, the method proceeds to step 400 (FIG. 3B), where the user's request is tested to determine whether an Other WSP has been requested. If it is determined that the requested WSP was the designated one, the user's compliance level is augmented in step 410.

Otherwise, if an Other WSP has been requested, the new request is processed in view of other compliance parameters (step 420), to determine whether one or more compliance criteria have been met (step 430), as will be described in detail below. If it is determined that compliance criteria have been met, the user's compliance level is augments in step 410.

The other compliance parameters referred to with respect to steps 350 and 420 may comprise, for example, any one or a combination of:
Time period in which no Other WSP has been used for the DS
Number of consecutive requests for the DS from the designated WSP
Number of DS requests during a predefined time period in which no Other WSP has been used
Number of DS requests from Other WSPs during a predefined time period
Number of DS requests from the designated WSP during a predefined time period

The reward may be implemented as goods, services, coupons, hard cash, or any other form of benefit to the compliant user.

### Sample Implementation

One sample implementation of the invention may be a music service seeking to provide free music in exchange for partially exclusive use with no usage requirements of a web-search engine owned by the same provider.

The rules:
The designated WSP: XX.com.
The designated service: XXSearch.com.
Compliance requirements: No usage requirement of the designated service.
The designated service on Other WSPs: www.google.com, search.yahoo.com, www.bing.com
The Reward: Free Music
Partially exclusive: Each time the users search an Other WSP they lose 1 point of compliance. Every day, users gain 1 point of compliance, but may possess no more than 10 points.
Users starts with 10 points of compliance
As long as they have any compliance points they get to play free music

The implementation:
An Internet Explorer BHO and a Firefox Add-on receive daily updates with a list of regular expressions detailing Other WSPs.
Since there is no usage requirement of the designated WSP service, no information is passed regarding the designated WSP.
Each user has an account that records how many compliance points the user has. At registration, each user receives 10 points.
The BHO and Firefox Add-on track every HTTP request and determine whether it is a web search on an Other WSP. If it is, one compliance point is deducted and reported to the central server.
Every day a compliance point is added and reported to the central server, but never above 10.
A free music website is implemented—every time the user wishes to play a song, the central server is contacted to determine whether the user has any compliance points. If so, the Reward, free music, is given—the song is played.

The computer program for performing the method of the present invention may be stored in a computer readable storage medium. This medium may comprise, for example: magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof which would occur to persons skilled in the art upon reading the foregoing description.

1. A computerized method of rewarding compliant use of a designated web service (DS) provided by a designated web service provider (WSP), comprising:
storing identification parameters for the designated WSP and for Other WSPs;
storing a compliance definition comprising exclusivity and usage requirements;
receiving a user's DS request;
analyzing the DS request in view of the stored compliance definition;
updating the user's compliance level according to said analysis result; and
rewarding the user if the updated compliance level indicates eligibility to a reward.

2. The method of claim 1, wherein said compliance definition comprises different definitions for different users.

3. The method of claim 1, wherein said exclusivity requirements are selected from the group consisting of: fully exclusive and partially exclusive.

4. The method of claim 1, wherein said usage requirements are selected from the group consisting of: usage requirements and no usage requirements.

5. The method of claim 1, wherein said analyzing comprises updating parameters pertaining to said user's compliance.

6. The method of claim 5, wherein said parameters are selected from the group consisting of: time period in which no Other WSP has been used for the DS, number of consecutive DS requests from the designated WSP, number of DS requests during a predefined time period in which no Other WSP has been used, number of DS requests from Other WSPs during a predefined time period and number of DS requests from the designated WSP during a predefined time period.

7. The method of claim 1, wherein said rewarding comprises awarding the user free services of a second web service.

8. A system for rewarding compliant use of a designated web service (DS) provided by a designated web service provider (WSP), comprising:
a user device capable of hosting a web server;
a central web server communicating with said user device over the internet;
a compliance mechanism communicating with said user device and with said central web server; and
a reward mechanism communicating with said central server,
wherein said compliance mechanism stores identification parameters for the designated WSP and for Other WSPs and a compliance definition comprising exclusivity and usage requirements.

9. The system of claim 8, wherein said compliance mechanism is implemented as several distributed components.

10. The system of claim 8, wherein said compliance mechanism is installed on the user device.

11. The system of claim 8, wherein said compliance mechanism is installed on a network device.

12. The system of claim 11, wherein said network device is selected from the group consisting of: a router, a switch, a network gateway, firewall, Internet server and an independent device on the network path.

13. The system of claim 8, wherein said compliance definition comprises different definitions for different users.

14. The system of claim 8, wherein said exclusivity requirements are selected from the group consisting of: fully exclusive and partially exclusive.

15. The system of claim 8, wherein said usage requirements are selected from the group consisting of: usage requirements and no usage requirements.

16. The system of claim 8, wherein said compliance mechanism comprises means for storing identification parameters for the designated WSP and for Other WSPs, means for storing a compliance definition comprising exclusivity and usage requirements, means for receiving a user's DS request, means for analyzing the DS request in view of the stored compliance definition and means for updating the user's compliance level according to said analysis' result.

17. The system of claim 8, wherein said parameters are selected from the group consisting of: time period in which no Other WSP has been used for the DS, number of consecutive DS requests from the designated WSP, number of DS requests during a predefined time period in which no Other WSP has been used, number of DS requests from Other WSPs during a predefined time period and number of DS requests from the designated WSP during a predefined time period.

18. The system of claim 8, wherein said reward mechanism comprises means for awarding the user free services of a second web service.
